(19) United States
(12) Patent Application Publication
(10) Pub. No.: US 2009/0071431 A1
(43) Pub. Date: Mar. 19, 2009

(54) Intake manifold

(75) Inventors: Makoto FUJIMORI, Chita-gun (JP); Yukihiro DOKO, Chita-gun (JP)

Correspondence Address: OLIFF & BERRIDGE, PLC, P.O. BOX 320850, ALEXANDRIA, VA, 22320-4850, US

(73) Assignee: AISAN KOGYO KABUSHIKI KAISHA, OBU-SHI (JP)

(21) Appl. No.: 12/222,170

(22) Filed: Aug. 4, 2008

(30) Foreign Application Priority Data
Sep. 19, 2007 (JP) 2007-242889

(51) Int. Cl. F02M 35/104

(52) U.S. Cl. 123/184.55

(57) ABSTRACT

An intake manifold for supplying intake air to an internal combustion engine includes a surge tank for temporarily storing the intake air, an air-intake port through which the intake air will be introduced in the surge tank, the air-intake port being provided in the surge tank at a position closer to an outer cylinder of the internal combustion engine than a center of the surge tank in its longitudinal direction, a plurality of branch intake passages having inlets arranged in parallel in the surge tank, each passage being configured to supply the intake air introduced in the surge tank through the air-intake port to each cylinder of the internal combustion engine through each inlet, and a guide wall provided in the surge tank and configured to change a flow direction of the intake air introduced in the surge tank to direct the intake air toward specific one(s) of the inlets of the branch intake passages.

### BACKGROUND OF THE INVENTION

1. Field of the Invention

The present invention relates to an intake manifold provided in an intake passage and arranged to supply intake air (sucked air) to an internal combustion engine.

2. Description of Related Art

In an intake passage of an internal combustion engine, an intake manifold is provided for distributing and supplying intake air to each cylinder of the internal combustion engine. A surge tank of the intake manifold is required to have a smooth internal shape without disturbing the flow of intake air. This is because a poor flow of intake air in the surge tank is likely to deteriorate distributivity of intake air to each cylinder of the internal combustion engine.

Accordingly, various intake manifolds have been proposed, including some measures to enhance the distributivity to each cylinder of the internal combustion engine, that is, to uniformize the distribution of intake air among the cylinders. One of such intake manifolds, for example, is provided with a guide wall formed near an assembly section (in which intake air will flow) to guide intake air to an outer cylinder and a rib formed near an air exit to guide intake air to an inner cylinder against the flow of intake air from the assembly section to the outer cylinder. This intake manifold can reduce differences in amount of intake air between the inner cylinder and the outer cylinder to improve the distributivity of intake air to each cylinder. In such intake manifold, an air-intake port through which intake air is introduced from an intake passage to the intake manifold is provided in the assembly section.

In view of the limitation in mounting space, unlike the above intake manifold, some intake manifolds may not be configured such that an air-intake port (a throttle device) is arranged in an assembly section, namely, in the vicinity of the center of a surge tank in its longitudinal direction. Besides, a surge tank may not be designed to have a sufficient capacity. In recent years, particularly, electronic control of an internal combustion engine has advanced and hence various control devices are disposed around the internal combustion engine. Thus, a mounting limitation on an intake manifold tends to increase. In many cases, consequently, the air-intake port could not be provided close to the center of the surge tank in its longitudinal direction or the surge tank could not be designed to have a sufficient capacity. In those cases, the flow of intake air is liable to become poor in the surge tank, deteriorating the distributivity of intake air to each cylinder.

### BRIEF SUMMARY OF THE INVENTION

The present invention has an object to provide an intake manifold with improved distributivity of intake air to each cylinder of an internal combustion engine.

Additional objects and advantages of the invention will be set forth in part in the description which follows and in part will be obvious from the description, or may be learned by practice of the invention. The objects and advantages of the invention may be realized and attained by means of the instrumentalities and combinations particularly pointed out in the appended claims.

To achieve the purpose of the invention, there is provided an intake manifold for supplying intake air to an internal combustion engine, comprising: a surge tank for temporarily storing the intake air; an air-intake port through which the intake air will be introduced in the surge tank, the air-intake port being formed in the surge tank at a position which will be closer to an outer cylinder of the internal combustion engine than a center of the surge tank in its longitudinal direction; a plurality of branch intake passages having inlets arranged in parallel in the surge tank, each passage being configured to supply the intake air introduced in the surge tank through the air-intake port to each cylinder of the internal combustion engine individually through each inlet; and a guide wall provided in the surge tank and configured to change a flow direction of the intake air introduced in the surge tank so that the intake air is directed toward specific one or more of the inlets of the branch intake passages.

According to another aspect, the present invention provides an intake manifold for supplying intake air to an internal combustion engine, comprising: a surge tank for temporarily storing the intake air; an air-intake port through which the intake air will be introduced in the surge tank; and a plurality of branch intake passages having inlets arranged in parallel in the surge tank, each passage being configured to supply the intake air introduced in the surge tank through the air-intake port to each cylinder of the internal combustion engine individually through each inlet; wherein the inlet of the branch intake passage through which the intake air will be supplied to an outer cylinder of the internal combustion engine is larger in area than the inlet of the branch intake passage through which the intake air will be supplied to an inner cylinder of the internal combustion engine.

It is to be noted that, in the case of four-cylinder engine, the outer cylinder represents first and fourth cylinders and the inner cylinder presents second and third cylinders.

According to another aspect, the present invention provides an intake manifold for supplying intake air to an internal combustion engine, comprising: a surge tank for temporarily storing the intake air; an air-intake port through which the intake air will be introduced in the surge tank; and a plurality of branch intake passages having inlets arranged in parallel in the surge tank, each passage being configured to supply the intake air introduced in the surge tank through the air-intake port to each cylinder of the internal combustion engine individually through each inlet; wherein an interval between the inlets of the adjacent branch intake passages through which the intake air will be supplied to the cylinders whose intake strokes partly overlap in the internal combustion engine is wider than an interval between the inlets of the branch intake passages through which the intake air will be supplied to the cylinders whose intake strokes do not overlap.

### BRIEF DESCRIPTION OF THE DRAWINGS

The accompanying drawings, which are incorporated in and constitute a part of this specification illustrate an embodiment of the invention and, together with the description, serve to explain the objects, advantages and principles of the invention.

In the drawings,

FIG. 1 is a side view showing a schematic configuration of an intake manifold of a first embodiment;

FIG. 2 is a view showing a positional relation between guide walls in a surge tank and branch intake passages;

FIG. 3 is a sectional view along a line A-B-C-D in FIG. 2;

FIGS. 4A and 4B are views showing a flow of intake air in an intake manifold with no guide wall, indicating the air flow to a first cylinder #1;

FIGS. 5A and 5B are views showing a flow of intake air in the intake manifold with no guide wall, indicating the air flow to a second cylinder #2;

FIGS. 6A and 6B are views showing a flow of intake air in the intake manifold with no guide wall, indicating the air flow to a third cylinder #3;

FIGS. 7A and 7B are views showing a flow of intake air in the intake manifold with no guide wall, indicating the air flow to a fourth cylinder #4;

FIGS. 8A and 8B are views showing a flow of intake air in the intake manifold of the first embodiment, indicating the air flow to a first cylinder #1;

FIGS. 9A and 9B are views showing a flow of intake air in the intake manifold of the first embodiment, indicating the air flow to a fourth cylinder #4;

FIG. 10 is a graph showing flow rates of intake air flowing in the cylinders;

FIG. 11 is a sectional view showing a schematic configuration of an intake manifold of a second embodiment;

FIG. 12 is a graph showing flow rates of intake air flowing in the cylinders of the second embodiment;

FIG. 13 is a sectional view showing a schematic configuration of an intake manifold of a third embodiment; and

FIG. 14 is a chart showing combustion cycles of the cylinders of an engine.

### DETAILED DESCRIPTION OF THE PREFERRED EMBODIMENTS

A detailed description of a preferred embodiment of an intake manifold embodying the present invention will now be given referring to the accompanying drawings. In this embodiment, the present invention is applied to an intake manifold used in an intake system of a four-cycle four-cylinder engine.

### First Embodiment

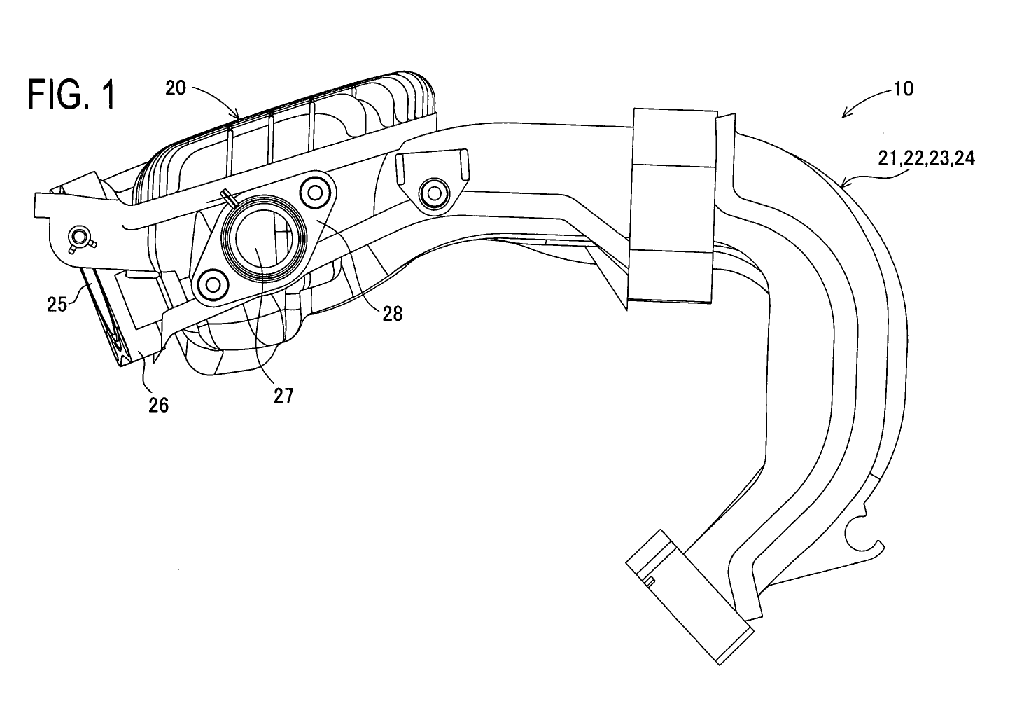

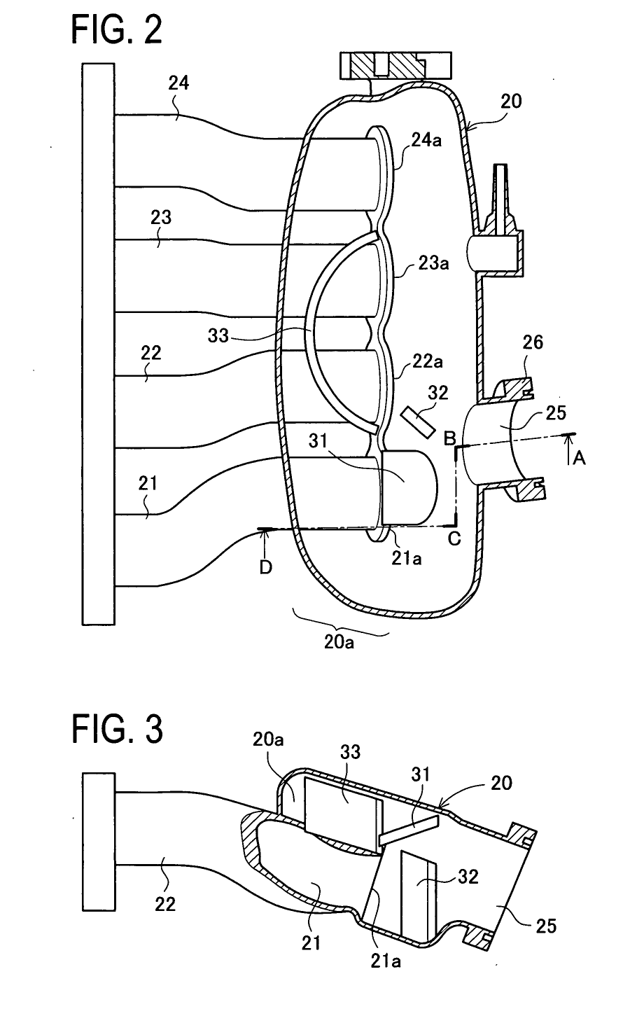

Firstly, a first embodiment will be described. An intake manifold of the first embodiment is explained referring to FIGS. 1 to 3. FIG. 1 is a side view showing a schematic configuration of the intake manifold of the first embodiment. FIG. 2 and 3 are views showing the shapes of guide walls in the intake manifold of the first embodiment.

An intake manifold 10 shown in FIG. 1 is an intake manifold made of resin, called “resin intake manifold”, mounted as an intake system component in a four-cycle four-cylinder engine to supply air (intake air) taken in an intake passage to each cylinder of the engine. This intake manifold 10 includes a surge tank 20 and four branch intake passages (hereinafter, “branch passages”) 21, 22, 23, and 24.

The surge tank 20 has a large hollow part as shown in FIG. 2, in which intake air is stored temporarily in order to prevent intake pulsation and intake interference or increase an intake efficiency. The branch passages 21 to 24 serve to supply the air introduced in the surge tank 20 to each cylinder of the engine. In this embodiment, the branch passage 21 serves for intake-air supply to a first cylinder #1; the branch passage 22 serves for intake-air supply to a second cylinder #2; the branch passage 23 serves for intake-air supply to a third cylinder #3; and the branch passage 24 serves for intake-air supply to a fourth cylinder #4, respectively.

The surge tank 20 is formed, in its side wall, with an air-intake port 25 through which intake air will be introduced into the surge tank 20. This air-intake port 25 is provided, on an end, with a flange 26 for connection to a throttle device. When the intake manifold 10 is mounted in the engine, the flange 26 is connected to a throttle device (not shown) including a throttle valve for regulating an amount of intake air. The intake air regulated in flow rate by the throttle device is allowed to flow in the surge tank 20 through the air-intake port 25. Herein, the throttle device is limited in position due to a mounting space limitation. The air-intake port 25 is thus formed at a position closer to an outer cylinder (a first cylinder #1 in this embodiment) side, not at the center of the surge tank 20 in the longitudinal direction.

One end of the surge tank 20 is formed with an EGR inlet port 27 whose end is attached with a flange 28 for connection to an EGR pipe. This flange 28 is coupled with the EGR pipe not shown to return part of exhaust gas from an exhaust system to an intake system. Accordingly, part of exhaust gas is allowed to return to the intake manifold 10.

The branch passages 21 to 24 are arranged in a side wall of the surge tank 20 opposite from another side wall formed with the air-intake port 25. Specifically, the branch passages 21 to 24 are connected to the surge tank 20 by leading ends (inlet sides) of the branch passages 21 to 24 inserted in the surge tank 20. Inlets 21a to 24a of the branch passages 21 to 24 are arranged in a row (in parallel) at equal intervals (at almost equal distances between adjacent two ports) in the surge tank 20. Those inlets 21a to 24a are almost equal opening area and the branch passages 21 to 24 are almost equal in passage length. The inlets 21a to 24a of the branch passages 21 to 24 are placed so that their axes are misaligned vertically with the axis of the air-intake port 25 as shown in FIG. 3. More specifically, the inlets 21a to 24a of the branch passages 21 to 24 are arranged in the surge tank 20 so that each axis of the inlets 21a to 24a is located below the axis of the air-inlet port 25.

The surge tank 20 is provided with three guide walls, namely a first guide wall 31, a second guide wall 32, and a third guide wall 33 as shown in FIGS. 2 and 3. Those guide walls 31 to 33 are made of the same material (synthetic resin in this embodiment) as that of the intake manifold 10. The guide walls 31 to 33 serve to change the flow direction of intake air in the surge tank 20 in order to evenly distribute the intake air to the branch passages 21 to 24.

The first guide wall 31 is a plate wall having a flat shape in section, attached to the branch passage 21 as shown in FIG. 2 or 3. Concretely, as shown in FIG. 3, the first guide wall 31 is fixed obliquely upward to an upper edge of the inlet 21a of the branch passage 21. This first guide wall 31 serves to change the flow direction of intake air in the surge tank 20 in order to increase the amount of intake air allowed to flow in the branch passage 21.

The second guide wall 32 is a plate wall having a flat shape in section, placed between the axis of the air-intake port 25 and the axis of the branch passage 22 as shown in FIG. 2. Specifically, as shown in FIGS. 2 and 3, the second guide wall 32 is fixed obliquely to the bottom of the surge tank 20 in order to allow the air introduced in the surge tank 20 through the air-intake port 25 to flow toward the branch passages 23 and 24. This second guide wall 32 serves to change the flow direction of intake air in the surge tank 20 in order to increase the amount of air allowed to flow in the branch passage 24.

The third guide wall 33 is a plate wall having a curved or circular arc shape in section in a space 20a defined by an outer wall around each outlet of the branch passages 21 to 24 and an inner wall of the surge tank 20 as shown in FIG. 2 or 3. More concretely, as shown in FIGS. 2 and 3, the third guide wall 33 is fixed to upper portions of the inlets 22a and 23a of the branch passages 22 and 23 so that both ends of the third guide wall 33 are located close to outer edges of the inlets 22a and 23a of the branch passages 22 and 23. This third guide wall 33 serves to change the flow direction of intake air in the space 20a in the surge tank 20 in order to increase the amount of intake air allowed to flow in the branch passage 24.

In the intake manifold 10 constructed as above, the air that is filtered by an air cleaner not shown and passes through the unillustrated throttle device is introduced in the surge tank 20 through the air-intake port 25. At that time, the amount of air to be introduced in the surge tank 20 is regulated by the unillustrated throttle device. In other words, an opening degree of a throttle valve of the throttle device is controlled to regulate the amount of air to be introduced in the surge tank 20. The air introduced in the surge tank 20 is distributed to the branch passages 21 to 24 and then supplied to the cylinders (#1 to #4) of the engine.

In the intake manifold 10 of the present embodiment, the air-intake port 25 is not located near the center of the surge tank 20 in its longitudinal direction. Furthermore, the surge tank 20 does not have a sufficiently large capacity. This is because the surge tank 20 cannot be designed to have a larger capacity due to the mounting space limitation of the intake manifold 10 in an engine room. When the air-intake port 25 is not located near the center of the surge tank 20 in the longitudinal direction and the surge tank 20 does not have a sufficient capacity, the intake manifold 10 may not evenly distribute intake air to the branch passages 21 to 24, which deteriorates distributivity of intake air.

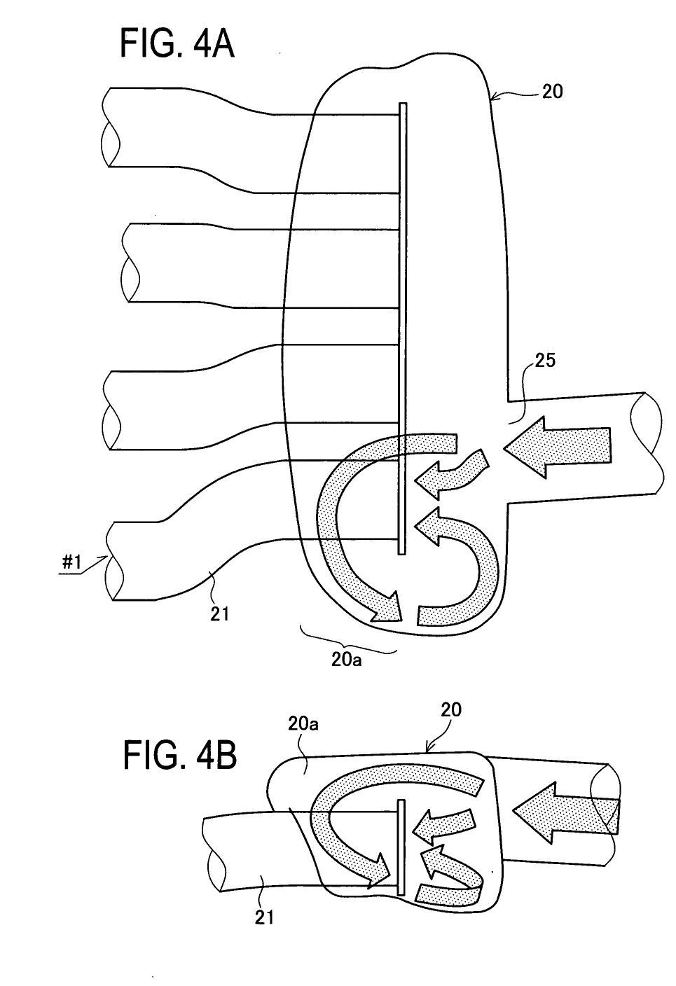

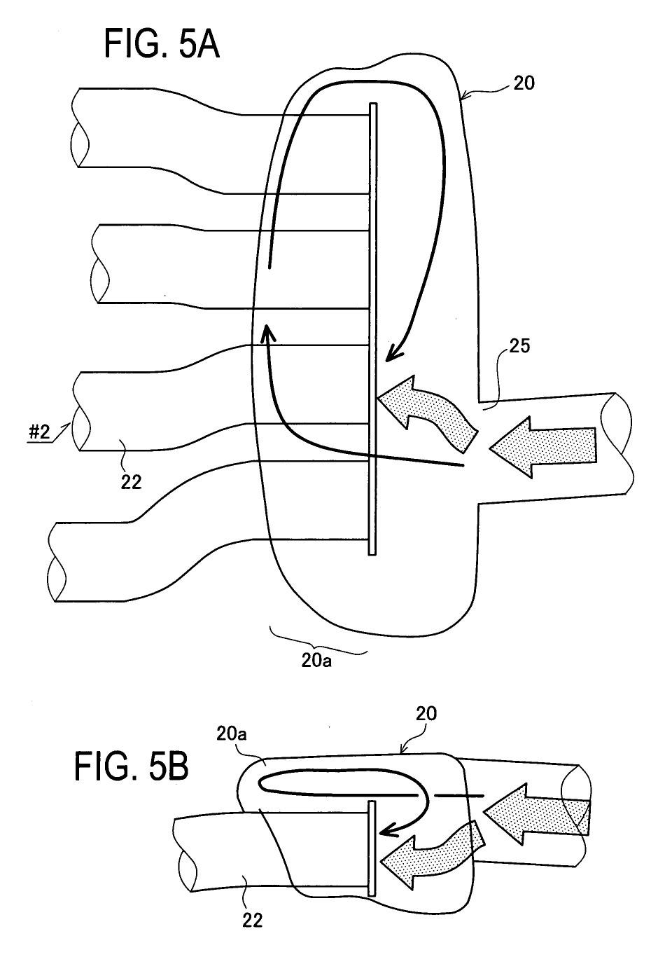

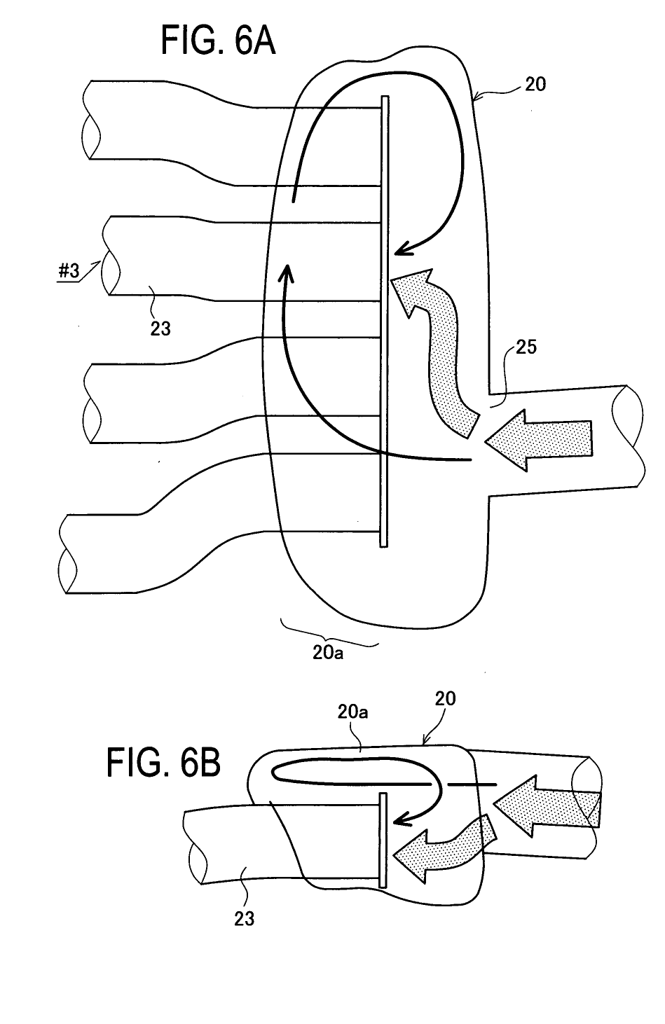

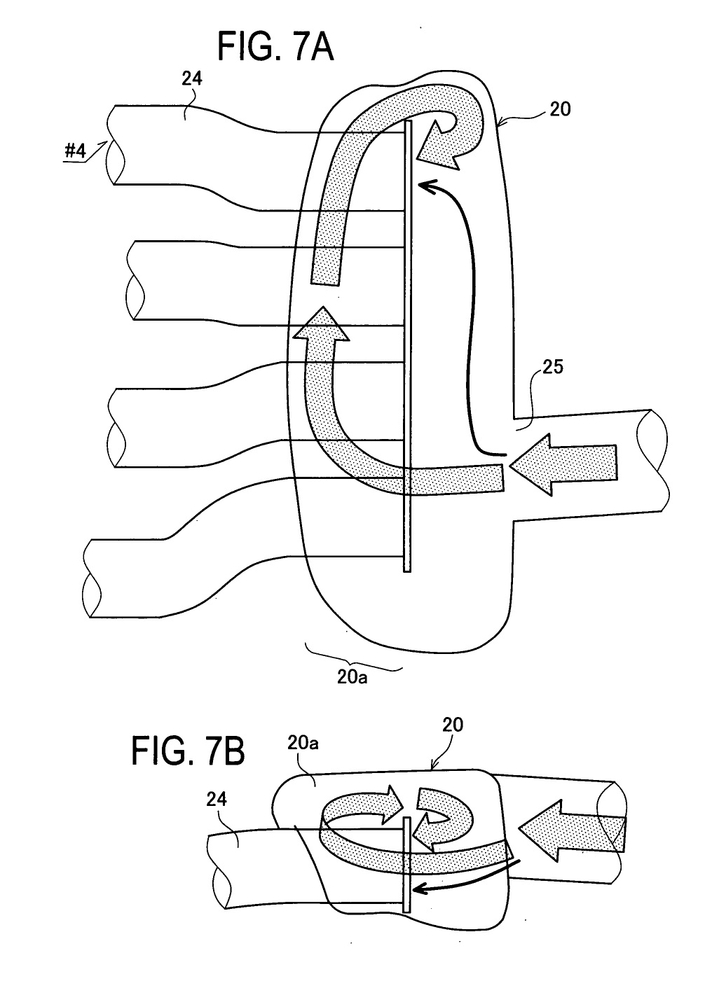

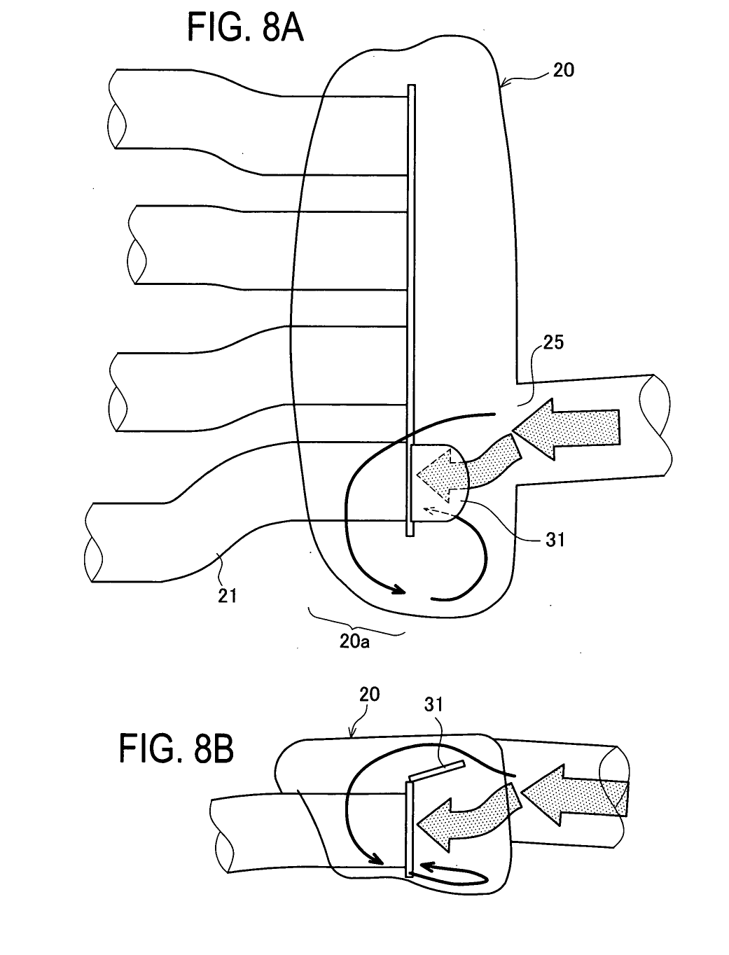

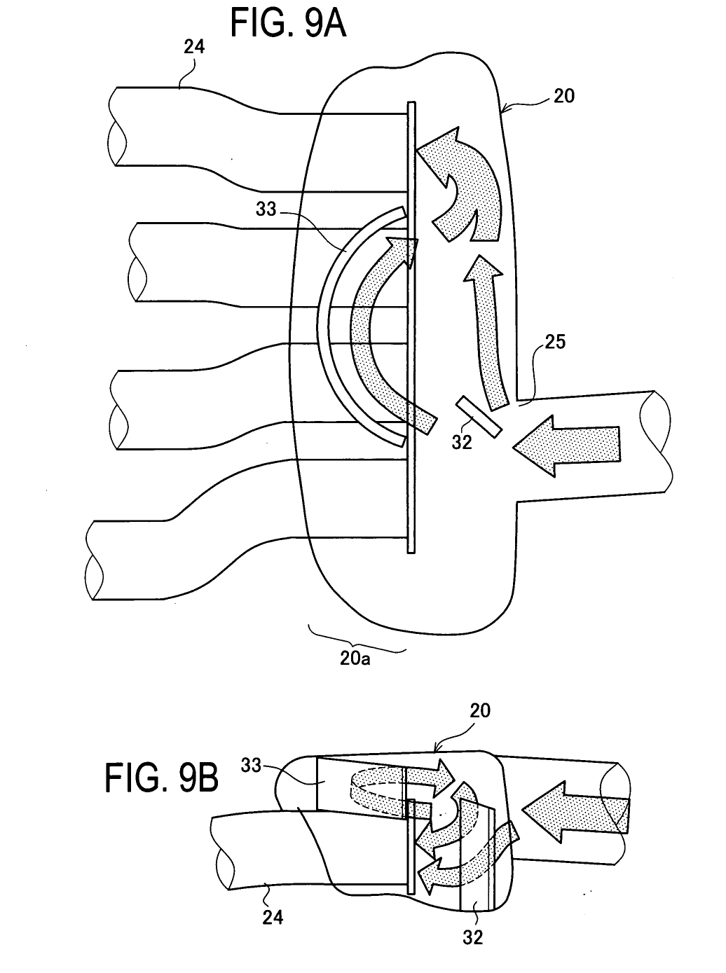

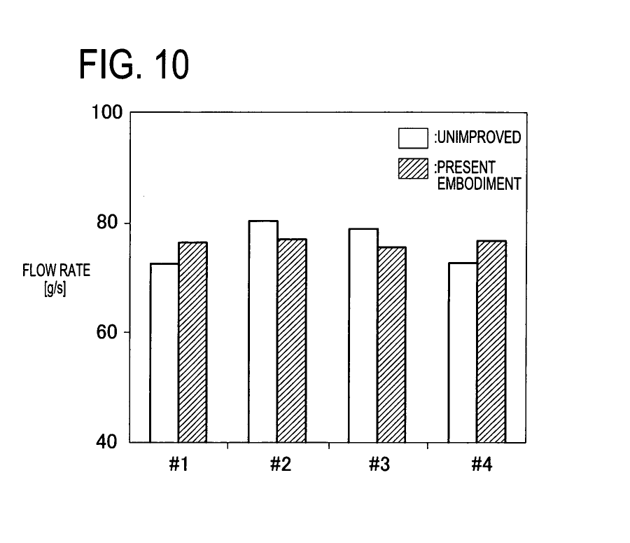

Herein, simulation analysis (CAE analysis) was executed on each branch passage (each cylinder) to analyze the flow of intake air in an intake manifold with no guide walls 31 to 33 (i.e., an unimproved intake manifold) and the flow of intake air in the intake manifold 10 of the present embodiment. The analysis results are shown in FIGS. 4 to 10. FIGS. 4A to 7B are views showing the flow of intake air in the intake manifold with no guide walls 31 to 33. Specifically, FIGS. 4A and 4B show an air flow to the first cylinder #1; FIGS. 5A and 5B show an air flow to the second cylinder #2; FIGS. 6A and 6B show an air flow to the third cylinder #3; and FIGS. 7A and 7B show an air flow to the fourth cylinder #4. FIGS. 8A, 8B, 9A, and 9B are views showing the flow of intake air in the intake manifold 10 of the present embodiment. Specifically, FIGS. 8A and 8B show an air flow to the first cylinder #1 and FIGS. 9A and 9B show an air flow to the fourth cylinder #4. FIG. 10 is a graph showing a flow rate of intake air flowing in each cylinder.

As is found from FIG. 10, in the unimproved intake manifold with no guide walls 31 to 33, the intake air amount to the second cylinder #2 is largest. The intake air amounts to the first and fourth cylinders #1 and #4 are less than those to the second and third cylinders #2 and #3. This reveals that the unimproved intake manifold could not evenly distribute intake air to each cylinder (each branch passage), leading to poor distributivity of intake air. From those results, it is found that it has only to increase the amount of intake air to be supplied to the first and fourth cylinders #1 and #4 in order to improve the distribution of intake air to each cylinder and enhance the intake air distributivity of the intake manifold.

Herein, the reason why a large amount of intake air is supplied to the second and third cylinders #2 and #3 in the unimproved intake manifold is conceived as follows. Almost all the intake air introduced in the surge tank 20 is directly supplied to each of the branch passages 22 and 23 through which the air is supplied to the second and third cylinders #2 and #3 without flowing in the space 20a in the surge tank 20 as shown in FIGS. 5A, 5B, 6A, and 6B. The intake air amount to the second cylinder #2 is larger than that to the third cylinder #3 because the branch passage 22 for supplying intake air to the second cylinder #2 is located closer to the air-intake port 25 of the surge tank 20.

On the other hand, the intake air amount to the first cylinder #1 is smallest. This is because the intake air introduced in the surge tank 20 through the air-intake port 25 is likely to flow in larger in a larger amount to the space 20a and then travels a circuitous path along the inner wall of the surge tank 20 to flow in the branch passage 21, as shown in FIGS. 4A and 4B, rather than to flow directly into the branch passage 21 for supplying intake air to the first cylinder #1.

In the unimproved intake manifold, furthermore, the air intake amount to the fourth cylinder #4 is smaller because the inlet of the corresponding branch passage 24 is located farthest from the air-intake port 25. As another reason, as shown in FIGS. 7A and 7B, the intake air introduced in the surge tank 20 through the air-intake port 25 is liable to flow in the space 20a and then travel a circuitous path along the inner wall of the surge tank 20, thus indirectly flowing in the branch passage 24 for supplying intake air to the fourth cylinder #4.

In the intake manifold 10 of the present embodiment, therefore, the surge tank 20 is provided with the guide walls 31 to 33 as mentioned above to increase the amount of intake air to be supplied to the first and fourth cylinders #1 and #4 (the branch passages 21 and 24).

The first guide wall 31 is placed to increase the amount of intake air to be supplied to the branch passage 21 (the first cylinder #1). As shown in FIGS. 8A and 8B, accordingly, part of the intake air that is introduced in the surge tank 20 and tends to flow in the space 20a is directed by the first guide wall 31 to flow directly in the branch passage 21. In other words, the first guide wall 31 changes the flow direction of the intake air that is introduced in the surge tank 20 and tends to flow in the space 20a to cause the intake air tending to flow in the space 20a to flow in the branch passage 21. Consequently, as shown in FIG. 10, the amount of intake air flowing in the branch passage 21 is increased, thus increasing the intake air amount to the first cylinder #1.

The second guide wall 32 and the third guide wall 33 are located to increase the amount of intake air to be supplied to the branch passage 24 (the fourth cylinder #4). As shown in FIGS. 9A and 9B, part of the intake air that is introduced in the surge tank 20 to flow in the space 20a of the surge tank 20 is directed by the third guide wall 33 to flow to the branch passage 24 without traveling along the inner wall of the surge tank 20. It is also shown that another part of the intake air introduced in the surge tank 20 is directed by the second guide wall 32 to directly flow in the branch passage 24 without flowing in the space 20a of the surge tank 20. By the second guide wall 32 and the third guide wall 33, the intake air that is introduced in the surge tank 20 and flows to the branch passage 24 is changed in flow direction. Specifically, the intake air flowing in the surge tank 20 through the air-intake port 25 is urged to flow in the branch passage 24. As a result thereof, a large amount of intake air is allowed to flow in the branch passage 24 as shown in FIG. 10 and thus the intake air amount to the fourth cylinder #4 can be increased.

The intake manifold 10 of the present embodiment as described above including the guide walls 31 to 33 in the surge tank 20 can increase the amount of intake air to be distributed to the branch passages 21 and 24 as shown in FIG. 10 to thereby increase the amount of intake air to be supplied to the first and fourth cylinders #1 and #4 and also decrease the amount of intake air to be distributed to the branch passages 22 and 23 to thereby reduce the amount of intake air to be supplied to the second and third cylinders #2 and #3. The reason why the amount of intake air flowing in the branch passages 22 and 23 decreases is conceived as that the flow of intake air directly flowing in the branch passages 22 and 23 from the air-intake port 25 is changed in flow direction by the second guide wall 32. As shown in FIG. 10, consequently, intake air is supplied in almost the same amount to each of the first to fourth cylinders #1 to #4. According to the intake manifold 10, the distributivity of intake air can be enhanced even where the air-intake port 25 is not located close to the center of the surge tank 20 in its longitudinal direction and the surge tank 20 has no sufficient capacity.

In the intake manifold 10 of the present embodiment, as described above in detail, the first to third guide walls 31 to 33 are provided in the surge tank 20. This makes it possible to improve low distributivity of intake air resulting from the configuration that the air-intake port 25 is not located close to the center of the surge tank 20 in the longitudinal direction and the surge tank 20 has no sufficient capacity. In the intake manifold 10, accordingly, the intake air introduced in the surge tank 20 can be distributed nearly evenly to the branch passages 21 to 24. According to the intake manifold 10, it is possible to enhance the intake distributivity even where the air-intake port 25 is not located close to the center of the surge tank 20 in the longitudinal direction and the surge tank 20 has no sufficient capacity.

### Second Embodiment

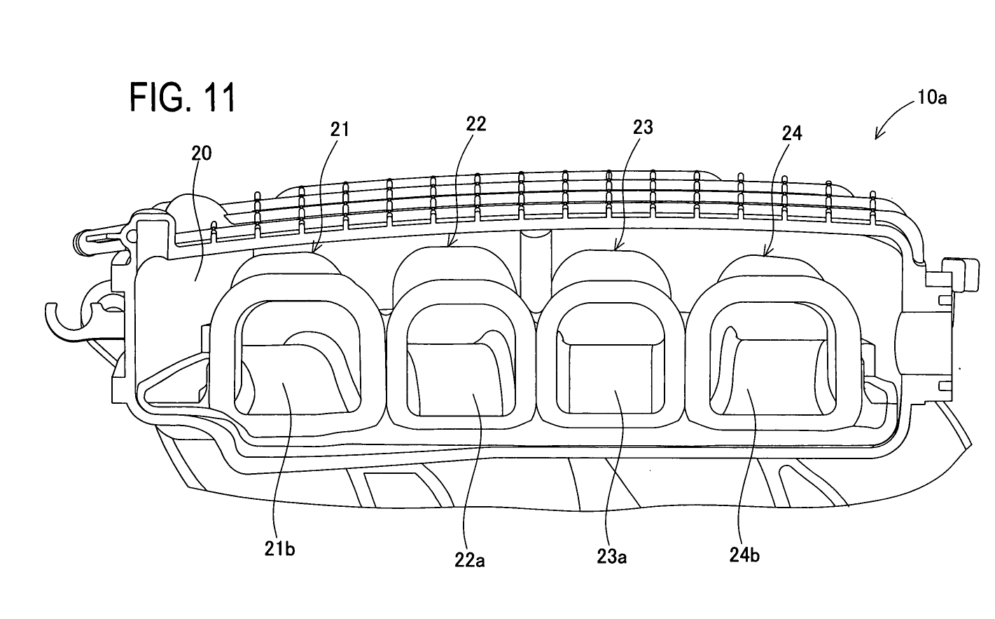

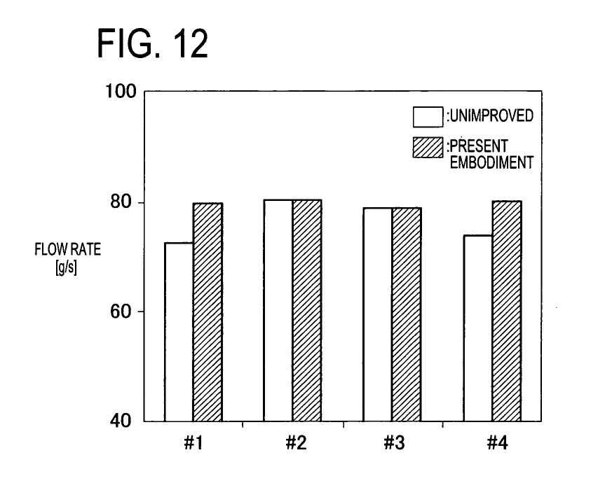

A second embodiment will be described below. This embodiment is substantially identical in basic structure to that in the first embodiment except that no guide wall is provided in the surge tank and the branch passages have inlets of different opening areas. Thus, identical components to those in the first embodiment are given the same reference signs and their explanations are omitted as appropriate. The intake manifold of the second embodiment is explained below with a focus on differences from the first embodiment, referring to FIGS. 11 and 12. FIG. 11 is a sectional view of the intake manifold of the second embodiment. FIG. 12 is a graph showing a flow rate of intake air flowing in each cylinder.

As shown in FIG. 11, an intake manifold 10a of the second embodiment is designed such that inlets 21b and 24b of the branch passages 21 and 24 are larger in area (opening area) than inlets 22a and 23a of the branch passages 22 and 23. More specifically, the area of each inlet 21b, 24b is determined in a range of about 1.2 to about 1.5 times as large as the area of each of the inlets 22a, 23a of the branch passages 22 and 23. In this embodiment, the area of each of the inlets 21b and 24b is about 1.3 times as large as the area of each of the inlets 22a and 23a. The inlets 21b and 24b of the branch passages 21 and 24 are almost equal in area.

The amount of intake air flowing in the branch passages 21 and 24 is liable to be less than that flowing in the branch passages 22 and 23 as mentioned above (refer to the unimproved configuration shown in FIG. 12). This is because as shown in FIGS. 4A to 7B, the intake air is allowed to directly flow from the air-intake port 25 to the branch passages 22 and 23, whereas the intake air is likely to flow in the branch passages 21 and 24 by traveling a circuitous path along the inner wall of the surge tank 20 rather than directly flowing from the air-intake port 25.

In the intake manifold 10a, on the other hand, the area of each of the inlets 21b and 24b of the branch passages 21 and 24 is determined to be larger (about 1.3 times) than that of each of the inlets 22a and 23a of the branch passages 22 and 23. Therefore, as shown in FIG. 12, the amount of intake air allowed to flow in the branch passages 21 and 24 for supplying intake air to the first and fourth cylinders #1 and #4 can be increased to about the same level as the amount of intake air allowed to flow in the branch passages 22 and 23.

According to the intake manifold 10a of the second embodiment, intake air can be distributed to each cylinder #1 to #4 without differences therebetween, thus enhancing the distributivity of intake air to each cylinder of the engine.

If it is experimentally found that the amount of intake air allowed to flow in the branch passage 24 is small, the intake manifold 10a of the second embodiment may also be designed such that the area of the inlet 24b of the branch passage 24 is larger than that of the inlet 21b of the branch passage 21. Specifically, the branch passages 21 and 24 for supplying intake air to the outer cylinders, i.e., the first and fourth cylinders #1 and #4, have only to be designed so that the area of the inlet 24b of the branch passage 24 farthest from the air-intake port 25 is larger than that of the inlet 21b of the branch passage 21 nearest the air-intake port 25.

With such configuration, even where the amount of intake air flowing in the branch passage 24 is estimated to be small, the amount of intake air allowed to flow in the branch passage 24 can be increased reliably to about the same level as that of intake air allowed to flow in the other branch passages 21 and 23. Consequently, it is possible to supply intake air to each cylinder of the engine without differences among the cylinders and thus reliably enhance the distributivity of intake air to each cylinder.

### Third Embodiment

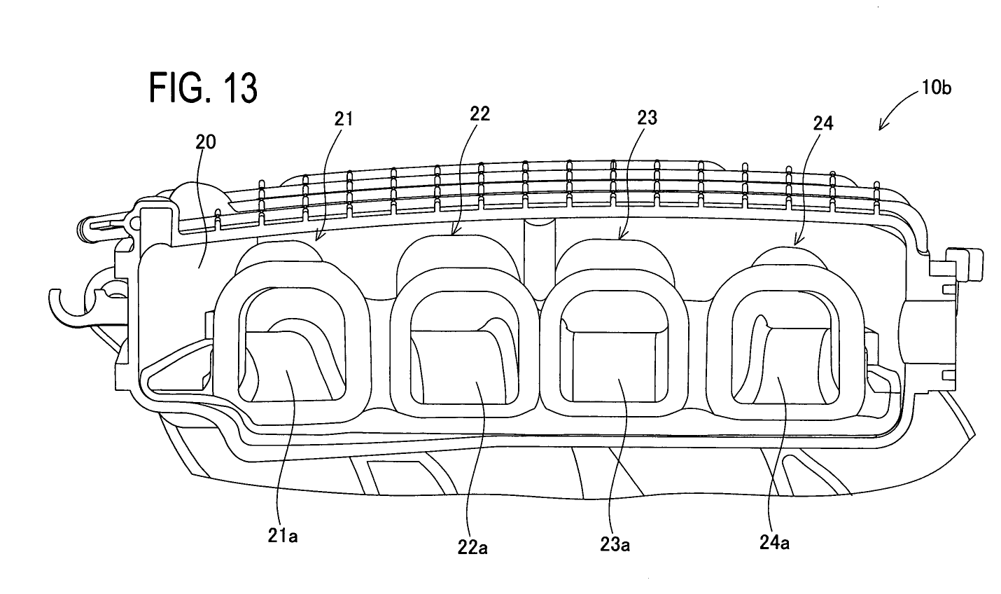

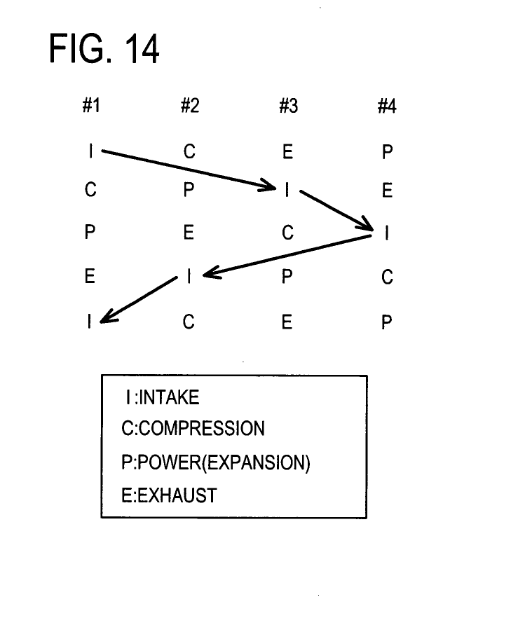

A third embodiment will be described. This embodiment is substantially identical in basic structure to that in the first embodiment except that no guide wall is provided in the surge tank and the inlets of the branch passages are arranged at different intervals (port-to-port distances). Thus, identical components to those in the first embodiment are given the same reference signs and their explanations are omitted as appropriate. The intake manifold of the third embodiment is explained below with a focus on differences from the first embodiment, referring to FIGS. 13 and 14. FIG. 13 is a sectional view of the intake manifold of the third embodiment. FIG. 14 is a chart showing combustion cycles of the cylinders of the engine.

As shown in FIG. 13, an intake manifold 10b of the third embodiment is designed such that an interval (a port-to-port distance) between the inlets 21a and 22a of the branch passages 21 and 22 and an interval (a port-to-port distance) between the inlets 23a and 24a of the branch passages 23 and 24 are wider than an interval (a port-to-port distance) between the inlets 22a and 23a of the branch passages 22 and 23.

In the case where the cylinders are to be ignited in the order of #1, #3, #4, and #2, the cycle of each cylinder containing four strokes: suction (intake), compression, power (expansion), and exhaust is repeated at the timing shown in FIG. 14. In the intake stroke of a certain cylinder, an intake valve in another cylinder will simultaneously be opened (“intake valve overlap” of different cylinders).

To be concrete, the intake stroke of the second cylinder #2 overlaps the intake stroke of the first cylinder #1. The first and second cylinders #1 and #2 are arranged adjacently and hence the intake stroke of the first cylinder #1 will be largely interfered by the intake stroke of the second cylinder #2 due to the intake valve overlap. The intake stroke of the third cylinder #3 overlaps the intake stroke of the fourth cylinder #4. The third and fourth cylinders #3 and #4 are also arranged adjacently and hence the intake stroke of the fourth cylinder #4 will be interfered largely by the intake stroke of the third cylinder #3 due to the intake valve overlap. Thus, the amount of intake air to the first and fourth cylinders #1 and #4 tends to become smaller.

On the other hand, the intake stroke of the fourth cylinder #4 overlaps the intake stroke of the second cylinder #2. However, the second and fourth cylinders #2 and #4 are located apart with the third cylinder #3 interposed therebetween. The intake stroke of the second cylinder #2 is therefore unlikely to be interfered by the intake stroke of the fourth cylinder #4 due to the intake valve overlap. The intake stroke of the first cylinder #1 overlaps the intake stroke of the third cylinder #3. However, the first and third cylinders #1 and #3 are also located apart with the cylinder #2 interposed therebetween. The intake stroke of the third cylinder #3 is therefore unlikely to be interfered by the intake stroke of the first cylinder #1 due to the intake valve overlap.

In the intake manifold 10b of the present embodiment, accordingly, the interval (port-to-port distance) between the inlets 21a and 22a of the branch passages 21 and 22 and the interval (port-to-port distance) between the inlets 23a and 24a of the branch passages 23 and 24 are determined to be wider than the interval (port-to-port distance) between the inlets 22a and 23a of the branch passages 22 and 23. Of pairs of the adjacent branch passages 21 and 22, 22 and 23, and 23 and 24, the pairs of branch passages for supplying intake air to the cylinders whose intake strokes partly overlap, that is, the inlets 21a and 22a of the branch passages 21 and 22 and the inlets 23a and 24a of the branch passages 23 and 24, are arranged at wider intervals than the inlets 22a and 23a of the branch passages 22 and 23 for supplying intake air to the cylinders whose intake strokes do not overlap.

In the intake manifold 10b, the branch passages 21 and 22 for supplying intake air to the first and second cylinders #1 and #2 which may cause the intake valve overlap are arranged at a wider port-to-port distance (a pitch distance) and also the branch passages 23 and 24 for supplying intake air to the third and fourth cylinders #3 and #4 which may cause the intake valve overlap are arranged at a wider port-to-port distance (a pitch distance). Accordingly, those branch passages 21 to 24 are prevented from becoming interfered by the intake stroke of a different cylinder. This makes it possible to prevent a decrease in amount of intake air to be supplied to the first and fourth cylinders #1 and #4 against the intake interference, that is, to increase the amount of intake air to the first and fourth cylinders #1 and #4. It is therefore possible to reduce differences in amount of intake air to be supplied to the first to fourth cylinders #1 to #4.

According to the intake manifold 10b of the third embodiment, intake air can be supplied to each cylinder #1 to #4 without differences among the cylinders, thus enhancing intake air distributivity to each cylinder of the engine.

If it is experimentally found that the amount of intake air allowed to flow in the branch passage 24 is small, the intake manifold 10b of the third embodiment may also be designed such that the area of the inlet 24a of the branch passage 24 is larger than that of the inlet 21a of the branch passage 21. Specifically, the branch passages 21 and 24 for supplying intake air to the outer cylinders, i.e., the first and fourth cylinders #1 and #4, have only to be designed so that the area of the inlet 24a of the branch passage 24 farthest from the air-intake port 25 is larger than that of the inlet 21a of the branch passage 21 nearest the air-intake port 25.

With such configuration and the increase in amount of intake air achieved by less interference by the intake stroke of a different cylinder, the amount of intake air allowed to flow in the branch passage 24 can further be increased even where the amount of intake air flowing in the branch passage 24 is estimated to be small. Consequently, it is possible to supply intake air to each cylinder of the engine without differences among the cylinders and thus reliably enhance the distributivity of intake air to each cylinder.

The present invention is not limited to the above embodiments and may be embodied in other specific forms without departing from the essential characteristics thereof. For instance, the invention may be applied not only to the intake manifold to be mounted in the four-cylinder engine as in the above embodiment but also to another intake manifold to be mounted in a three-, six-, or more cylinder engine.

Furthermore, the first to third embodiments may be combined arbitrarily, providing synergistic effects.

While the presently preferred embodiment of the present invention has been shown and described, it is to be understood that this disclosure is for the purpose of illustration and that various changes and modifications may be made without departing from the scope of the invention as set forth in the appended claims.

What is claimed is:

1. An intake manifold for supplying intake air to an internal combustion engine, comprising:
a surge tank for temporarily storing the intake air;
an air-intake port through which the intake air will be introduced in the surge tank, the air-intake port being formed in the surge tank at a position which will be closer to an outer cylinder of the internal combustion engine than a center of the surge tank in its longitudinal direction;
a plurality of branch intake passages having inlets arranged in parallel in the surge tank, each passage being configured to supply the intake air introduced in the surge tank through the air-intake port to each cylinder of the internal combustion engine individually through each inlet; and
a guide wall provided in the surge tank and configured to change a flow direction of the intake air introduced in the surge tank so that the intake air is directed toward specific one or more of the inlets of the branch intake passages.

2. The intake manifold according to claim 1, wherein
the guide wall includes a wall configured to direct at least part of the intake air that is introduced in the surge tank and tends to flow to a space defined by an outer wall of each branch intake passage and an inner wall of the surge tank toward the inlet of the branch intake passage through which the intake air will be supplied to an outer cylinder which will be located closer to the air-intake port.

3. The intake manifold according to claim 2, wherein
the wall is provided obliquely upward on an upper edge of the inlet of the branch intake passage through which the intake air will be supplied to the outer cylinder which will be closer to the air-intake port.

4. The intake manifold according to claim 1, wherein
the guide wall includes a wall configured to direct at least part of the intake air that is introduced in the surge tank and tends to flow to the inlets of the branch intake passages through which the intake air will be supplied to an outer cylinder and an inter cylinder which will be located closer to the air-intake port toward the inlet of the branch intake passage through which the intake air will be supplied to an outer cylinder which will be located opposite from the air-intake port in the longitudinal direction of the surge tank.

5. The intake manifold according to claim 4, wherein the wall is provided between an axis of the air-intake port and an axis of the branch intake passage adjacent to the branch intake passage through which the intake air will be supplied to the outer cylinder which will be located closer to the air-intake port.

6. The intake manifold according to claim 1, wherein
the guide wall include a wall configured to direct at least part of the intake air that is introduced in the surge tank and tends to flow to a space defined by an outer wall of each branch intake passage and an inner wall of the surge tank toward the inlet of the branch intake passage placed farthest from the air-intake port.

7. The intake manifold according to claim 6, wherein
the wall is a plate wall having a circular arc shape in section and is provided in the space defined by the outer wall of each branch intake passage and the inner wall of the surge tank.

8. The intake manifold according to claim 2, wherein
the axis of the air-intake port and the axis of the branch intake passage are misaligned vertically.

9. The intake manifold according to claim 6, wherein
the axis of the air-intake port and the axis of the branch intake passage are misaligned vertically.

10. An intake manifold for supplying intake air to an internal combustion engine, comprising:
a surge tank for temporarily storing the intake air;
an air-intake port through which the intake air will be introduced in the surge tank; and
a plurality of branch intake passages having inlets arranged in parallel in the surge tank, each passage being configured to supply the intake air introduced in the surge tank through the air-intake port to each cylinder of the internal combustion engine individually through each inlet;
wherein the inlet of the branch intake passage through which the intake air will be supplied to an outer cylinder of the internal combustion engine is larger in area than the inlet of the branch intake passage through which the intake air will be supplied to an inner cylinder of the internal combustion engine.

11. The intake manifold according to claim 10, wherein
the area of the inlet of the branch intake passage through which the intake air will be supplied to the outer cylinder is about 1.2 to about 1.5 times as large as that of the branch intake passage through which the intake air will be supplied to the inner cylinder.

12. The intake manifold according to claim 10, wherein
the areas of the inlets of the branch intake passages through which the intake air will be supplied to the outer cylinders of the internal combustion engine are determined so that the area of the inlet of the branch intake passage located apart from the air-intake port is larger than the area of the inlet of the branch intake passage located closer to the air-intake port.

13. An intake manifold for supplying intake air to an internal combustion engine, comprising:
a surge tank for temporarily storing the intake air;
an air-intake port through which the intake air will be introduced in the surge tank; and
a plurality of branch intake passages having inlets arranged in parallel in the surge tank, each passage being configured to supply the intake air introduced in the surge tank through the air-intake port to each cylinder of the internal combustion engine individually through each inlet;
wherein an interval between the inlets of the adjacent branch intake passages through which the intake air will be supplied to the cylinders whose intake strokes partly overlap in the internal combustion engine is wider than an interval between the inlets of the branch intake passages through which the intake air will be supplied to the cylinders whose intake strokes do not overlap.

14. The intake manifold according to claim 13, wherein
the inlet of the branch intake passage through which the intake air will be supplied to an outer cylinder of the internal combustion engine is larger in area than the inlet of the branch intake passage through which the intake air will be supplied to an inner cylinder of the internal combustion engine.

15. The intake manifold according to claim 14, wherein
the areas of the inlets of the branch intake passages through which the intake air will be supplied to the outer cylinders of the internal combustion engine are determined so that the area of the inlet located apart from the air-intake port is larger than the area of another inlet located closer to the air-intake port.
